(19) United States
(12) Patent Application Publication
(10) Pub. No.: US 2020/0115551 A1
(43) Pub. Date: Apr. 16, 2020

(54) IMPROVED HEAT AND ELECTRICALLY RESISTIVE THERMOPLASTIC RESIN COMPOSITIONS

(71) Applicant: DSM IP Assets B.V., Heerlen (NL)

(72) Inventors: Geert Adelina Rudolf VAN DEN POEL, Echt (NL); Zhihao CAI, Echt (NL); Youchum ZHANG, Echt (NL)

(21) Appl. No.: 16/471,090

(22) PCT Filed: Dec. 21, 2017
(86) PCT No.: PCT/NL2017/050865

§ 371 Date: Jun. 19, 2019

(30) Foreign Application Priority Data
Dec. 22, 2016 (CN) 201611202699.5
Jan. 23, 2017 (EP) 17152701.3

(51) Int. Cl. C08L 77/06

(52) U.S. Cl. CPC C08L 77/06; C08L 2201/08; C08L 2201/02; C08L 2205/025

(57) ABSTRACT

Described herein are heat and electrically resistive thermoplastic resin compositions containing a resin matrix including specified blends of a first polyamide with a higher melting point than a second included polyamide, a flame retardance package including both a halogenated and non-halogenated flame retardant constituent and limited quantities of various synergists, and optionally, one or more additives. Also disclosed are methods of creating articles from the described compositions, as well as the articles themselves.

### TECHNICAL FIELD

The present invention relates to heat and electrically resistive thermoplastic resin compositions, and various articles formed therefrom.

### BACKGROUND

Thermoplastic resin compositions for producing various articles are well-known. Depending on the end-use application for which a particular thermoplastic resin composition is intended, various physical properties become paramount. One common application of thermoplastic resin compositions is in forming shaped electrical and electronics articles. Electrical and electronic applications include for example systems for power transfer as well as data transfer via electrical circuitry and electronic components, such as electronic communication systems, computers, cell phones, auto electronics, lighting, and home appliances, to name a few. Electronic components can include, to specify a few non-limiting examples, connectors, molded case circuit breakers, bobbins, relays, inductors, din rails, and enclosures.

Typically, thermoplastic resin compositions containing a polyamide are often used for the production of such shaped articles. The polyamide is a synthetic polymer widely used for making various thermoplastic articles produced by known methods such as injection molding. Technical polyamides are commonly used for producing articles in such fields (such as electrical and electronics), particularly where optimization of properties such as flowability, impact resistance, dimensional stability at high temperatures, surface finish, and density is sought.

Furthermore, glass fibers and one or more flame retardants with flame retardant synergists are often added to the polyamide resin matrix for the production of such shaped articles for electrical and electronics applications, because they tend to impart at least one of high stiffness, elevated flame retardance, and/or improved electrical resistivity into the shaped articles produced therefrom. Many of the most commonly-used flame retardants, in particular synergists such as antimony trioxide, are either expensive or introduce environmental concerns, however.

Attempts to improve flame retardancy of compositions based on polyamide resins have long been known. US2012/0276391 teaches that an excessively high amount of flame retardant agents in a polyamide matrix results in a deterioration of the mechanical properties in the solid parts formed therefrom. Furthermore, it is taught that from EP2935430A1 the maximum amount of a brominated flame retardant is 40% or so by weight, relative to the weight of the polymer matrix, to presumably ensure adequate flame retardance alongside adequate mechanical properties.

Further, a filled thermoplastic resin composition is described in, EP2297237A1, to DSM IP Assets BV. This reference discloses flame-retardant compositions including: (A) polyamide, (B) melamine cyanurate and (C) talcum as mineral filler. The object of that disclosure is to provide for polyamide compositions with increased amounts of talcum which still have acceptable burning times or flame retardancy.

Flame retardancy can be measured in various ways, of which the glow wire flammability index test (hereafter referred to as GWFI-test, or simply GWFI) is commonly used to gauge the relative performance of electrical and electronic parts. The GWFI-test can be measured at various temperatures, of which 960° C. is the most stringent criterion. Miniature circuit breakers, for instance, have to comply to the GWFI-test at this temperature. The test measures the ability to extinguish a flame caused by the application of a glow wire according to standard IEC 60695-2-12 to test specimens with a specified thickness and a surface area of at least about 3500 mm² at a preset temperature of the glow wire. The composition passes the test when either there is no ignition of the specimen or when there is ignition but it self-extinguishes within 30 seconds after removal of the said glow wire. The composition passes the test at a certain temperature if, by successive testing, three different specimens self-extinguish within 30 seconds after removal of said glow wire or do not ignite at all.

Another method to evaluate flame retardancy is to record burning times between the start of applying a glow wire at a certain temperature and the moment the flame self-extinguishes. It should be understood that the burning time may be shorter than the application time of the glow wire. This method allows for a more quantitative evaluation compared to the GWFI-test, as the GWFI-test is a pass/no- pass-test.

Another glow wire-based test that is often-used test for determining the flame retardancy of various polymeric compositions is the Glow Wire Ignition Temperature (GWIT). This test simulates the effect of heat as it may arise in malfunctioning electrical equipment, such as with overloaded or glowing components. The test provides a way of comparing the temperatures at which thermoplastic resin compositions ignite under these circumstances.

Yet another method for assessing a polymeric material's flammability is according to the UL-94 standard. This standard is particularly designed for plastic materials which are to be incorporated into devices and appliances. Ratings according to the UL 94 V test are as apportioned per the following generalized criteria:

| | | | Burning | Burn to |
|---|---|---|---|---|
| Rating | Afterflame Time | Total Burning Time | Drips | Clamp |
| V-0 | ≤10 seconds | ≤50 seconds | No | No |
| V-1 | ≤30 seconds | ≤250 seconds | No | No |
| V-2 | ≤30 seconds | ≤250 seconds | Yes | No |

An article is deemed to have failed the UL 94 test if the afterflame time exceeds 30 seconds, or if the burn to clamp result is yes.

As noted, flame retardant thermoplastic resin compositions are used extensively for the manufacture of articles and parts for electrical applications. For such purposes it is often required, however, that the thermoplastic resin composition exhibit a high electrical resistivity in addition to excellent flame retardance properties.

One well-known proxy for determining an articles sufficiency of electrical resistance is the comparative tracking index (CTI) test. This property is important for applications in many fields, such as the field of electronics, as it measures the electrical breakdown properties, also known as tracking, of the material. CTI is usually denoted by a number, optionally followed by a number between brackets. The first number denotes the voltage at which the material with a thickness of 3 mm can withstand 50 drops of ammonium chloride solution. The second number between brackets shows which voltage was obtained while withstanding 100 drops. All reported CTI values are measured in accordance with IEC60112.

Despite the foregoing, it is evident that a heretofore unmet need exists to provide thermoplastic resin compositions suitable for use in electrical and electronics applications that exhibit “extreme safety”, or sufficient elongation at break, toughness, and stiffness, all while simultaneously exhibiting superior flame retardance as measured by GWFI, GWIT, and UL-94, and superior electrical resistivity as measured by CTI, further capable of the aforementioned often in the absence of the requirement for costly and/or environmentally detrimental common flame retardant synergists.

### BRIEF SUMMARY

Described herein are several embodiments of the invention. A first embodiment is a thermoplastic resin composition comprising, relative to the weight of the entire thermoplastic resin composition, a resin matrix comprising a blend of at least a first polyamide and a second polyamide; a flame retardance package comprising a halogenated flame retardant constituent and a non-halogenated flame retardant constituent; and from 0% up to about 60 wt. %, or up to about 40 wt. %, or about 20 wt. % of one or more additives; wherein the ratio by weight of the first aliphatic polyamide to the second aliphatic polyamide is from about 1:1 to about 75:1, or from about 5:1 to about 75:1; wherein the first polyamide possesses a melting point that is higher than the melting point of the second polyamide; and wherein the resin composition contains less than about 5 wt. %, or less than about 3 wt. %, or less than about 1 wt. %, or less than about 0.5 wt. %, or less than about 0.1 wt. %, or less than about 0.05 wt. % of an antimony trioxide.

Further embodiments of the invention are described below.

### DETAILED DESCRIPTION

Throughout this document, if a composition or component is referred to as “substantially devoid of” a particular substance or constituent, such as with respect to, e.g., a synergist, a co-polyamide, or a filler, or relies upon other similar nomenclature relative to any other substance, it is meant that the entire composition contains less than about 3 parts per million of the referenced substance or constituent, when measured by conventional methods (such as atomic emission spectroscopy) which are well-known according to those of ordinary skill in the art to which this invention applies.

A first aspect of the present invention is a thermoplastic resin composition comprising, relative to the weight of the entire thermoplastic resin composition, a resin matrix comprising a blend of at least a first polyamide and a second polyamide; a flame retardance package comprising a halogenated flame retardant constituent and a non-halogenated flame retardant constituent; and from 0% up to about 60 wt. %, or up to about 40 wt. %, or about 20 wt. % of one or more additives; wherein the ratio by weight of the first aliphatic polyamide to the second aliphatic polyamide is from about 1:1 to about 75:1, or from about 5:1 to about 75:1; wherein the first polyamide possesses a melting point that is higher than the melting point of the second polyamide; and wherein the resin composition contains less than about 5 wt. %, or less than about 3 wt. %, or less than about 1 wt. %, or less than about 0.5 wt. %, or less than about 0.1 wt. %, or less than about 0.05 wt. % of an antimony trioxide.

At a fundamental level, compositions according to the present invention possess a resin matrix, a flame retardant package, and optionally, one or more additives, each of which is described in turn below.

### Resin Matrix

Compositions according to the present invention possess a resin matrix. The resin matrix may comprise one or more resin matrix polymers. Preferably, the one or more matrix polymers are thermoplastic materials. In an embodiment, the resin matrix comprises one or more polyamides (PAs).

A polyamide is a macromolecule with repeating units linked by amide bonds. All polyamides are made by the formation of an amide function to link two molecules of monomer together, produced either by the reaction of a diacid with a diamine or by ring-opening polymerization of lactams. A variety of processes for the production of polyamides are known, which, depending on the desired end product, necessitate the utilization of different monomer units and various chain regulators for establishing a desired molecular weight.

The industrially relevant processes for producing polyamides typically involve polycondensation in a melt. In this context, the hydrolytic polymerization of lactams is also understood as polycondensation. Often used are partly crystalline polyamides, which are polyamides which can be prepared starting from diamines and dicarboxylic acids and/or lactams having at least 5 ring members or corresponding amino acids.

Typical reactants used are aliphatic and/or aromatic dicarboxylic acids, including adipic acid, 2,2,4- and 2,4,4-trimethyladipic acid, azelaic acid, sebacic acid, isophthalic acid, terephthalic acid, aliphatic and/or aromatic diamines, such tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropane, bisaminomethylcyclohexane, phenylenediamines, xylylenediamines, amino carboxylic acids, aminocaproic acid, or any of the corresponding lactams.

In any event, polyamides may be obtained by a number of well-known processes, including, but not limited to, those described in U.S. Pat. Nos. 2,071,250, 2,071,251, 2,130,523, 2,130,948, 2,241,322, 2,312,966, and 2,512,606.

Polyamides may be aliphatic or aromatic. Aromatic polyamides (otherwise known as aramids), are often considered to possess superior toughness and/or modulus, along with better solvent, heat, and flame resistance, all coupled with superior dimensional stability than their aliphatic counterparts, but are typically more expensive to produce and supply. Two of the most well-known aromatic amides include poly(p-phenylene terephthalamide) and poly(m-phenylene isophthalamide). The fully aromatic structure and the strong hydrogen bonds between adjacent aramid chains yield high melting points, high tensile strength at low weight, and excellent flame and heat resistance.

The aliphatic polyamides (otherwise known as nylons) are typically more readily available and are therefore suitable for a greater number of applications. They are amorphous or only moderately crystalline when injection molded, but the degree of crystallinity can be much increased for fiber and film applications by orientation via mechanical stretching. Two of the most well-known polyamides are poly(hexamethylene adipamide) (PA66 or Nylon 6,6) and polycaprolactam (PA6 or Nylon 6). Both PA6 (CAS #25038-54-4) and PA66 (CAS #32131-17-2) have excellent mechanical properties including high tensile strength, toughness, flexibility, resilience, and low creep. They are easy to dye and exhibit excellent resistance to wear due to a low coefficient of friction (self-lubricating). Nylons typically possess a high melting temperature and glass transition temperature, thereby enabling the solid polymers formed therefrom to possess superior mechanical properties even at increased temperatures. For example, the heat deflection temperature (HDT) of PA-6,6 is typically between 180 and 240° C., which exceeds those of polycarbonate and polyester. They also have good resistance to oils, bases, fungi, and many solvents.

Another well-known polyamide is Nylon 6,12. It is less hydrophilic than Nylons 6,6 and 6 due to the larger number of methylene groups in the polymer backbone. For this reason, it has better moisture resistance, dimensional stability, and electrical properties, but the degree of crystallinity, the melting point and the mechanical properties are lower. Other non-limiting commercially available polyamides include Nylon 4,6, Nylon 6,10 and Nylon 11.

Polyamides used in embodiments of the present invention may include all polyamides, crystalline, semicrystalline as well as amorphous or mixtures thereof. A survey of polyamides can be found e.g. in Römpp Chemie-Lexikon, 9th edition, volume 5, starting from page 359, and the citations mentioned therein. Specifically, the polyamides PA 6, PA 46, PA 66, PA 11, PA 12, PA 6T/66, PA 6T/6I, PA 6I/6 T, PA 6/6T, PA 6/66, PA 8T, PA 9T, PA 12T, PA 69, PA 610, PA 612, PA 1012, PA 1212, PA MACM12, PA PACM12, PA MACMT, PA PACP12, PA NDT, PA MXDI, PA NI, PA NT, PA TMHMDAT, PA 12/PACMT/PACMI, PA 12/MACMI/MACMT, PA N12, PA 6/MACMI or blends thereof may be used. Examples of commonly commercially available polyamides include PA66, PA6, PA3, PA7, PA8, PA10, PA11, PA12, PA410, PA610, and PA46.

Whether aromatic or aliphatic, polyamides may be homopolymeric or copolymeric. Polyamide homopolymers can for example be made from a diamine (X) and a diacid (Y) and are generally known as an AABB type polyamide, e.g. PA-612 denotes a homopolymer with building blocks hexane-1,6-diamine (HMDA) and 1,12-dodecanoic acid. Polyamide homopolymers can also be made from an amino acid (Z) are generally known as AB-type polyamide, e.g. PA-6 denotes a homopolymer from ε-caprolactam.

Copolyamides are known and generally described in Nylon Plastics Handbook, Edited by Melvin I. Kohan, Hanser Publishers, 1995, especially beginning at page 365. A copolyamide herein is understood to be a copolyamide which derives some of its monomeric units from hexamethylene diamine and adipic acid, with further monomeric units derived from a diamine and a diacid and/or an aminoacid. These further monomeric units are thus different from hexamethylene diamine or adipic acid.

A copolyamide is usually described as either PA-XY/MN, wherein PA-XY is a AABB type polyamide, or PA-Z/MN, wherein PA-Z is an AB-type polyamide and wherein M and N are present in lower amounts than the first mentioned monomeric units. By way of example, such copolyamides may be denoted as PA-66/XY, in which X refers to a further diamine and Y refers to a further diacid or PA-66/Z, in which Z refers to an aminoacid or PA-66/XY/Z.

The nomenclature is adhered to as used in Nylon Plastics Handbook, Edited by Melvin I. Kohan, Hanser Publishers, 1995; e.g. PA-612 denotes a homopolymer with building blocks hexane-1,6-diamine and 1,12-dodecanoic acid, PA-6/12 denotes a copolymer made from ε-caprolactam and laurolactam. This notation is silent about the type of copolyamide. The copolyamide can thus be random, block or even alternating.

A copolyamide is to be distinguished from a blend, which is for example denoted as PA-66/PA-XY or PA-66/PA-Z. A blend is prepared by mixing two polyamides, whereas a copolyamide is prepared by mixing monomers which subsequently polymerize to a copolyamide. With monomers is herein understood a molecule that when chemically bound to other monomers forms a polymer. For polyamides, potential monomers include for example aminoacids, diamines and diacids, as well as their salts. By way of further example, a blend of PA-6 and PA-12 is described as PA-6/PA-12.

Semi-crystalline polyamides are herein to be understood as being homopolymers, copolymers, blends and grafts of synthetic long-chain polyamides having recurring amide groups in the polymer main chain as an essential constituent. Examples of polyamide homopolymers are polyamide-6 (PA 6, polycaprolactam, polycondensation of epsilon-caprolactam), polyamide-10 (PA 10, polydecanoamide), polyamide-11 (PA 11, polyundecanolactam), polyamide-12 (PA 12 polydodecanolactam), polyamide-6, 6 (PA 66, polyhexamethyleneadipamide, polycondensation product of hexamethylene diamine and adipic acid), polyamide-6,9 (PA 69, condensation product of polycondensation product of 1,6-hexamethylene diamine and azelaic acid), polyamide-4, 10 (PA 410, polycondensation product of diaminobutane and 1,10-decanedioic acid), polyamide-6, 10 (PA 610, polycondensation product of 1,6-hexamethylene diamine and 1,10-decanedioic acid), polyamide-6, 12 (PA 612, polycondensation product of 1,6-hexamethylenediamine and 1,12-dodecanedioic acid), polyamide 10,10 (PA 1010, polycondensation product of 1,10-decamethylenediamine and 1,10-decanedicarboxylic acid), PA 1012 (polycondensation product of 1,10-decamethylenediamine and dodecanedicarboxylic acid) or PA 1212 (polycondensation product of 1,12-dodecamethylenediamine and dodecanedicarboxylic acid).

Polyamide copolymers may comprise the polyamide building blocks in various ratios. Examples of polyamide copolymers are polyamide 6/66 and polyamide 66/6 (PA 6/66, PA 66/6, copolyamides made from PA 6 and PA 66 building blocks, i.e., those made from ε-caprolactam, hexamethylenediamine and adipic acid). PA 66/6 (90/10) may contain 90 percent of PA 66 and 10 percent of PA 6. A further example includes polyamide 66/610 (PA 66/610, made from hexamethylenediamine, adipic acid and sebacic acid). Polyamide copolymers may also comprise cyclic building blocks including aromatic building blocks, such as isophorone diamine, terephtalic acid, isophtalic acid, such as for example PA 6/IPDT and PA6I/6T. In an embodiment, the polyamide copolymers comprise cyclic building blocks in an amount less than building blocks of chosen from the group of epsilon-caprolactam, hexamethylene diamine, adipic acid, and combinations thereof.

In an embodiment, the semi-crystalline polyamides have as main building blocks ε-caprolactam and/or building blocks of hexamethylene diamine and adipic acid, including PA-6, PA-66, PA6/66 and PA66/6 and blends thereof.

In an embodiment, the resin matrix includes a polyamide-6, polyamide-7, polyamide-6,6, polyamide-4,6, or blends thereof. Preferably, the resin matrix includes polyamide-6 and a polyamide-6,6. In an embodiment, the polyamide-6 and polyamide-6,6 have a relative solution viscosity higher than 2, or higher than 2.2, and lower than 3, or lower than 2.8. The relative solution viscosity is measured according to ISO 307 and determined using a solution of 1 gram of the relevant resin matrix constituent in 100 ml of 90% strength formic acid at 25° C.

In an embodiment, suitable polyamides generally have 0.1 to 1 amine group as end groups per linear chain molecule, the amine groups content preferably being at least 20 meq/kg, more preferably 30 meq/kg and most preferably 40 meq/kg. The advantage of a higher amine groups content is a stronger increase in viscosity and more pronounced non-Newtonian melt flow behavior.

In an embodiment, the resin matrix preferably comprises a blend of two or more separate polyamides. Inventors have found that certain blends of multiple polyamides advantageously harnesses the benefits of multiple individual matrix polymer constituents, allowing for a composition with a better balance of desired properties, such as the simultaneous maintenance of high-performance in terms of heat/flame resistance, electrical resistivity, ready miscibility with flame retardant package constituents described elsewhere herein, and acceptable mechanical properties (such as material stiffness and elongation at break), without the express need for reinforcing agents or fillers. Inventors have further surprisingly discovered that certain blends of at least two polyamides, when configured in appropriate quantities, and when selected with appropriate heat resistance characteristics, yield a resin matrix that synergistically works with flame retardants—without the need for separate expensive and/or environmentally unfriendly flame retardant synergists—thereby enabling optimal performance in heat, flame, and electrical resistivity.

The individual polyamides may be chosen from one or more of the examples listed elsewhere herein. In an embodiment, however, the polyamides are chosen such that a blend yields a first polyamide with a higher melting point than a second polyamide. In a preferred embodiment, the resin matrix comprises a first polyamide with a melting point above about 250° C., and a second polyamide with a melting point below about 250° C.

Inventors have surprisingly found that resin matrices according to the present invention may become particularly optimized for enabling the formation of thermoplastic articles possessing superior heat and electrical resistivity if certain blends of at least two distinct thermoplastic polymers are employed in amounts that are controlled relative to each other.

In a preferred embodiment, therefore, the blend of thermoplastic polymers comprises two separate polyamides, with a first polyamide possessing a higher melting point than the second polyamide, wherein the ratio by weight of the first polyamide to the second polyamide is from about 1:1 to about 50:1, or from about 1:1 to about 25:1; or from about 5:1 to about 50:1, or from about 5:1 to about 25:1, or from about 5:1 to about 15:1. In a preferred embodiment, these aforementioned ratios apply to a first polyamide with a melting point above 250° C., and a second polyamide with a melting point below 250° C. Inventors have surprisingly discovered that the unique combination of heat and electrical resistivity tend to decrease if too much or too little of the second polyamide with a lower melting point, particularly below 250° C., is included.

In an embodiment at least one of the polyamides is an aliphatic polyamide. In an embodiment, at least the first and second polyamides are aliphatic polyamides. In another embodiment, at least a third additional polymer is included, although it is generally present in the composition in an amount lower by weight than the first or second polyamides. The individual polyamides may be homopolyamides or copolyamides, or a combination of both.

In an embodiment, the at least two polyamides are aliphatic polyamides. In an embodiment, the aliphatic polyamides include PA6 and PA66.

In a preferred embodiment, the resin matrix is configured such that the molar heat capacity of the aliphatic polyamides used is optimized for applications as electrical connectors in, e.g., home appliances. In a preferred embodiment, therefore, the resin matrix comprises a first aliphatic polyamide with a molar heat capacity, Cₚ, when tested in accordance with ASTM E1269-11, of at least about 250 J(mol K)⁻¹, or at least about 275 J(mol K)⁻¹, or at least about 300 J(mol K)⁻¹, or more preferably at least about 325 J(mol K)⁻¹; and a second aliphatic polyamide possesses a molar heat capacity Cₚ of less than about 325 J(mol K)⁻¹, or less than about 300 J(mol K)⁻¹, or less than about 275 J(mol K)⁻¹, more preferably less than about 250 J(mol K)⁻¹.

Molar heat capacity values for various common aliphatic polyamides are well-known. For example, known calculated molar heat capacity values include the following:

| | Calculated Molar Heat Capacity |
|---|---|
| Aliphatic Polyamide | Values (in J(mol K)⁻¹) |
| PA3 | 82-100 |
| PA6 | 155-179 |
| PA8 | 214-232 |
| PA10 | 260-275 |
| PA11 | 284-313 |
| PA66 | 333-355 |
| PA6, 10 | 427-449 |

In an embodiment, the first or second aliphatic polyamide is PA66, which is a homopolyamide that consists essentially of monomeric units derived from hexamethylene diamine and adipic acid.

In an embodiment, the first or second aliphatic polyamide is PA6, a commercial example of which is Akulon F132-E, available from DSM, the Netherlands.

In an embodiment, the resin matrix further includes one or more flow modifiers. For the purposes of this invention, a flow modifier changes the melt viscosity of the accompanying resin matrix. Suitable flow modifiers include diluent monomers, but oligomers are generally preferred. In an embodiment, the suitable oligomeric flow modifier is at least one polyamide oligomer. Suitable polyamide oligomers include the polyamides with low molecular weight listed elsewhere herein as suitable for use in the resin matrix. Preferred polyamide oligomers are polyamide-6 oligomers, polyamide-4,6 oligomers, polyamide-6,6 oligomers or a mixture of at least two of these oligomers. The polyamide oligomer is a low-molecular weight polyamide having a weight-average molecular weight that is preferably lower than the “molecular weight between entanglements” of the base polyamide in the resin matrix. This “molecular weight between entanglements” is for example 5,000 g/mol in the case of polyamide-6. Preferably, the weight average molecular weight is at most 5,000 g/mol, preferably at most 4,000 g/mol, more preferably at most 3,000 g/mol. However, if the molecular weight becomes too low, the glass transition temperature of the resin composition into which the flow modifier is incorporated may decrease to an undesirable level. Preferably the weight-average molecular weight is greater than approximately 500 g/mol, more preferably greater than approximately 1,000 g/mol.

In an embodiment, the resin matrix comprises a flow improver as described herein in an amount of from 0.1 to 50 wt. % (relative to the total resin matrix). More preferably, the resin matrix comprises a flow improver in an amount of from 0.1 to 40 wt. %, even more preferably in an amount of from 0.1 to 30 wt. % and even more preferably in an amount of from 0.1 to 20 wt. % (relative to the total resin matrix).

The polymer constituents forming the resin matrix, including the aforementioned aliphatic polyamides, may be obtained by mixing the components by any known method. For instance the components may be dry blended and consequently fed into a melt mixing apparatus, preferably an extruder. Also the components can be directly fed into a melt mixing apparatus and dosed together or separately. Preferably the melt mixing is performed in an inert gas atmosphere and the materials are dried before mixing.

In an embodiment, the resin matrix is employed, relative to the weight of the entire resin composition, of from 25 to 85 wt. %, or from 30 to 80 wt. %, or from 35 to 75 wt. %, or from 40 to 70 wt. %, or from 45 to 65 wt. %.

### Flame Retardance Package

Compositions according to the present invention also possess a flame retardance package. A flame retardance package, as described herein, pertains to a flame retardant or combination of flame retardants, as those terms are commonly known and understood in the art to which this invention applies. Specifically, the flame retardance package excludes materials which form the resin matrix (including thermoplastic polymers such as polyamides), and further tend to contribute to the function of improving the ability of the composition into which they are incorporated to resist fire damage, prevent the spread of a fire, or delay the point at which a fire may begin. Such effects are commonly quantified by performance relative to a component's performance on the glow wire ignition test (GWIT), or glow wire flammability index (GWFI).

Flame retardants are commonly known to act in one of several ways to disrupt a combustion process. First, they might dilute and disrupt a dangerous concentration of flammable gases and oxygen in a flame formation zone by emitting flame suppressing fluids such as water or inert gases. They may also disrupt the combustion stage of a fire cycle, including avoiding or delaying “flashover,” or the burst of flames that engulfs a confined area. Additionally, flame retardants might act to delay a material's decomposition process by forming a “char” layer thereon and physically insulating the fire from fuel rich materials beyond the char layer.

In accordance with an embodiment, the composition contains a flame retardance package comprising at least two flame retardant constituents. In an embodiment, at least one flame retardant constituent contains one or more halogen-free compounds. In an embodiment, at least one flame retardant constituent contains one or more halogen-containing compounds. In an embodiment, the flame retardant package comprises a halogenated flame retardant constituent further comprising at least one halogenated flame retardant compound, and a non-halogenated flame retardant constituent further comprising at least one halogen-free, or non-halogenated flame retardant compound.

The composition can include any suitable amount of a flame retardance package, for example, in certain embodiments, relative to the weight of the entire composition, in an amount up to about 60 wt. %, or about 50 wt. %, or about 40 wt. %, or about 30 wt. %, or in certain embodiments, in an amount of at least about 5 wt. %, or at least about 10 wt. %, or at least about 20 wt. %, or at least about 30 wt. %. In an embodiment, the flame retardance package is present in an amount, relative to the weight of the entire composition, of from 10 wt. % to about 60 wt. %, more preferably from about 20 wt. % to about 50 wt. %, more preferably from about 30 wt. % to about 40 wt. %.

In an embodiment, the ratio by weight of the halogenated flame retardant constituent described below to the non-halogenated flame retardant constituent described below is from about 1:25 to about 25:1, or from about 2:1 to about 15:1, or from about 4:1 to about 10:1.

### Halogenated Flame Retardants

In multiple embodiments, the flame retardance package includes a halogenated flame retardant constituent. The halogenated flame retardant consists of one or more halogenated (or halogen-containing) flame retardants. This signifies that the flame retardance package incorporates one or more flame retardants that include a halogenated compound. A halogenated compound is a combination of one or more chemical compounds that includes a halogen atom. Halogens are a group of elements that include fluorine, astatine, chlorine, bromine and iodine.

In an embodiment, the halogenated flame retardant constituent includes one or more brominated and chlorinated compounds, such as epoxidized tetrabromobisphenol A resin, tetrachlorobisphenol A oligocarbonate, pentabromopolyacrylate, ethylene-1,2-bistetrabromophthalimide, brominated polystyrene, bis (pentabromophenyl) ethane, tetrabromobisphenol A oligocarbonate, and combinations thereof.

In an embodiment, one or more bromine-containing flame retardants are used in the halogenated flame retardant constituent. Organobromine flame retardants include, without limitation, tetrabromobisphenol A (TBBPA) and its derivatives such as esters, ethers, and oligomers, for example tetrabromophthalate esters, bis(2,3-dibromopropyloxy)tetrabromobisphenol A, brominated carbonate oligomers based on TBBPA, brominated epoxy oligomers based on condensation of TBBPA and epichlorohydrin, and copolymers of TBBPA and 1,2-dibromoethane; dibromobenzoic acid, dibromostyrene (DBS) and its derivatives; ethylenebromobistetrabromophthalimide, dibromoneopentyl glycol, dibromocyclooctane, trisbromoneopentanol, tris(tribromophenyl)triazine, 2,3-dibromopropanol, tribromoaniline, tribromophenol, tetrabromocyclopentane, tetrabromobiphenyl ether, tetrabromodipentaerythritol, decabromodiphenyl ether, tetrabromophthalic anhydride, pentabromotoluene, pentabromodiphenyl ether, pentabromodiphenyl oxide, pentabromophenol, pentabromophenyl benzoate, pentabromoethylbenzene, hexabromocyclohexane, hexabromocyclooctane, hexabromocyclodecane, hexabromocyclododecane, hexabromobenzene, hexabromobiphenyl, octabromobiphenyl, octabromodiphenyl oxide, poly(pentabromobenzyl acrylate), octabromodiphenyl ether, decabromodiphenyl ethane, decabromodiphenyl, brominated trimethylphenylindan, tetrabromochlorotoluene, bis(tetrabromophthalimido)ethane, bis(tribromophenoxy)ethane, brominated polystyrene, brominated epoxy oligomer, polypentabromobenzyl acrylate, dibromopropylacrylate, dibromohexachlorocyclopentadienocyclooctane, N′-ethyl(bis)dibromononboranedicarboximide, tetrabrombisphenol S, N′N′-ethylbis(dibromononbornene)dicarboximide, hexachlorocyclopentadieno-bis-(2,3-dibromo-1-propyl)phthalate, brominated phosphates like bis(2,3-dibromopropyl)phosphate and tris(tribromoneopentyl)phosphate and tris(dichlorobromopropyl)phosphite, N,N′-ethylene-bis-(tetrabromophthalimide), tetrabromophthalic acid diol[2-hydroxypropyl-oxy-2-2-hydroxyethyl-ethyltetrabromophthalate], vinylbromide, polypentabromobenzyl acrylate, polybrominated dibenzo-p-dioxins, tris-(2,3-dibromopropyl)-isocyanurate, ethylene-bis-tetrabromophthalimide and tris(2,3-dibromopropyl)phosphate.

Suitable examples of commercially available brominated flame retardants include polybrominated diphenyl oxide (DE-60F), decabromodiphenyl oxide (decabromodiphenyl ether) (DBDPO; SAYTEX® 102E), tris[3-bromo-2,2-bis(bromomethyl)propyl]phosphate (PB 370®, FMC Corp. or FR 370, ICL/Ameribrom), tris(2,3-dibromopropyl)phosphate, tetrabromophthalic acid, bis-(N,N′-hydroxyethyl)tetrachlorphenylene diamine, tetrabromobisphenol A bis(2,3-dibromopropyl ether) (PE68), brominated epoxy resin, ethylene-bis(tetrabromophthalimide) (SAYTEX® BT-93), octabromodiphenyl ether, 1,2-bis(tribromophenoxy)ethane (FF680), tetrabromo-bisphenol A (SAYTEX® RB 100), ethylene bis-(dibromo-norbornanedicarboximide) (SAYTEX® BN-451), tris-(2,3-dibromopropyle)-isocyanurate, hexabromocyclododecane, brominated polystyrene and EMERALD INNOVATION series from Chemtura, for example EMERALD INNOVATION 1000.

In an embodiment, the halogenated flame retardant constituent comprises one or more of the organobromine flame retardants decabromodiphenyl ether, tris[3-bromo-2,2-bis(bromomethyl)propyl] phosphate, or brominated polystyrene.

If employed, the composition can include any suitable amount of a halogenated flame retardant constituent, for example, in certain embodiments, relative to the weight of the entire composition, in an amount up to about 50 wt. %, or about 40 wt. %, or about 30 wt. %, or in certain embodiments, in an amount of at least about 5 wt. %, or at least about 10 wt. %, or at least about 20 wt. %, or at least about 30 wt. %. In an embodiment, the halogenated flame retardant constituent is present in an amount, relative to the weight of the entire composition, of from 10 wt. % to about 50 wt. %, or from about 20 wt. % to about 50 wt. %, or from about 30 wt. % to about 40 wt. %.

One or more of the aforementioned halogen-containing flame retardants described herein may be added to the halogenated flame retardant constituent of the flame retardance package in pure form, or in masterbatches or compacts.

### Non-Halogenated Flame Retardants

In multiple embodiments, the flame retardance package includes a non-halogenated flame retardant constituent. The non-halogenated flame retardant constituent comprises one or more non-halogenated (or halogen-free) flame retardants. This signifies that the flame retardance package incorporates one or more flame retardants that do not contain a halogen compound, meaning a combination of one or more chemical compounds that are substantially devoid of a fluorine, astatine, chlorine, bromine or iodine atom.

Halogen-free flame retardants are generally desired because they facilitate recycling, are less hazardous for the environment, and often contribute to the improvement in comparative tracking index performance. In an embodiment, the non-halogenated flame retardant constituent is present in an amount, relative to the entire composition, of between about 4 wt. % and 25 wt. %. The presence of a halogen-free flame retardant has as advantage that the polyamide composition according to the invention can also be applied in applications in which flame retardancy and electrical insulation is required, such as for example in components for electrical and electronic applications.

In an embodiment, the non-halogenated flame retardant constituent includes at least one nitrogen-containing flame retardant, or a mixture of multiple nitrogen-containing flame retardants. It may also contain inorganic nitrogen-containing compounds such as ammonium salts, or in particular ammonium polyphosphate. Further nitrogen-containing examples include melamine oxalate, melamine phosphate, and melamine phosphate. These may be reaction products of melamine with condensed phosphoric acids or reaction products of condensates of melamine with phosphoric acid or with condensed phosphoric acids, in particular melamine, as well as the reaction products of melamine and polyphosphoric with basic aluminum, magnesium and/or zinc compounds, and also melamine cyanurate neopentylglycol boric acid. Also suitable are guanidine as guanidine carbonate, guanidine cyanurate, guanidine phosphate, pentaerythritol boric acid, neopentylglycolboric acid guanidine, urea phosphate and urea cyanurate. Moreover, condensates of melamine, in particular melem, melam, or more highly condensed compounds of this type and their reaction products can be used with condensed phosphoric acids. Also suitable are tris (hydroxyethyl) isocyanurate or its reaction products with carboxylic acids, benzoguanamine and its adducts or salts, and its substituted on the nitrogen products as well as their salts and adducts. As other nitrogen containing components are allantoin compounds, and also their salts with phosphoric acid, boric acid or pyrophosphoric acid, and glycolurils or their salts.

In an embodiment, the non-halogenated flame retardant constituent includes at least one triazine-type flame retardant, such as melamine, melamine cyanurate, melam, melem, ammeline, ammelide, as well as mixtures thereof.

In a preferred embodiment, the non-halogenated flame retardant constituent includes a melamine-containing compound. Melamine-based flame retardants are a family of non-halogenated flame retardants that include at least one of the following chemical groups: melamine(2,4,6-triamino-1,3,5 triazine); melamine derivatives (including salts with organic or inorganic acids, such as boric acid, cyanuric acid, phosphoric acid or pyro/poly-phosphoric acid); melamine homologues, and melamine condensation products.

In the context of this application a melamine derivative is understood to be melamine with one or more amine groups having been substituted with one or more alkyl, aryl, aralkyl or cycloalkyl groups, for example to be chosen from the group comprising methyl, ethyl, ethenyl, phenyl or toluyl. Examples of such melamine derivatives are N,N′,N″-triphenylmelamine. Melamine derivatives also include, for example, melamine cyanurate (a salt of melamine and cyanuric acid), melamine-mono-phosphate (a salt of melamine and phosphoric acid), melamine pyrophosphate and melamine polyphosphate. Furthermore, in the context of this application, a melamine condensation product is understood to be a compound in which two or more melamine compounds are connected to one another, for example melam, melem, melon and higher oligomers and menthone, which condensation products can for example be obtained using the process described in WO 96/16948. Melamine homologues include melam(1,3,5-triazin-2,4,6-triamine-n-(4,6-diamino-1,3,5-triazine-2-yl), melem(2,5,8-triamino 1,3,4,6,7,9,9b-heptaazaphenalene) and melon(poly[8-amino-1,3,4,6,7,9,9b-heptaazaphenalene-2,5-diyl). In an embodiment, the melamine-based flame retardant of the non-halogenated flame retardant constituent is phosphorous-free.

In an embodiment, the halogen-free melamine based flame retardant is chosen from the group of melamine, melamine cyanurate, melam, melem and melon and mixtures thereof. The advantage is that processing of the polyamide compounds in the resin matrix, particularly aliphatic polyamides, is easier and that deposition of volatile components in the mold is reduced.

In a preferred embodiment, the non-halogenated flame retardant constituent includes a melamine cyanurate (MeCy) flame retardant compound. Melamine cyanurate, which is synthesized via the reaction of melamine with cyanuric acid, is represented by the empirical formula C₆N₉O₃. It possesses a melting point at about 350° C. Commercial examples include, without limitation, Melapur® MC 25 and MC50 Melapur® (Fa. BASF, Ludwigshafen, Germany). If included, in an embodiment the composition may contain from about 5 wt. % to about 45 wt. % melamine cyanurate.

Other suitable halogen-free flame-retardants are for example phosphorus compounds, such as organic phosphates, phosphites, phosphonates and phosphinates. Examples of such compounds are described in for example Kirk Othmer, Encyclopedia of Chemical Technology, Vol. 10, p. 396 et seq. (1980), as well as, for example, in EP1 104766, JP07292233, DE19828541, DE1988536, JP11263885, and U.S. Pat. Nos. 4,079,035, 4,107,108, 4,108,805, and 6,265,599. Non-halogenated phosphorous-based flame retardants are compounds that include phosphorous, such as triphenyl phosphates, phosphate esters, phosphonium derivatives, phosphonates, phosphoric acid esters and phosphate esters, and those described in, for example, U.S. Pat. No. 7,786,199. Phosphorous-based flame retardants are usually composed of a phosphate core to which is bonded alkyl (generally straight chain) or aryl (aromatic ring) groups. Examples include red phosphorous, inorganic phosphates, insoluble ammonium phosphate, ammonium polyphosphate, ammonium urea polyphosphate, ammonium orthophosphate, ammonium carbonate phosphate, ammonium urea phosphate, diammonium phosphate, ammonium melamine phosphate, diethylenediamine polyphosphate, dicyandiamide polyphosphate, polyphosphate, urea phosphate, melamine pyrophosphate, melamine orthophosphate, melamine salt of dimethyl methyl phosphonate, melamine salt of dimethyl hydrogen phosphite, ammonium salt of boron-polyphosphate, urea salt of dimethyl methyl phosphonate, organophosphates, phosphonates and phosphine oxide. Phosphate esters include, for example, trialkyi derivatives, such as triethyl phosphate, tris(2-ethylhexyl)phosphate, trioctyl phosphate, triaryl derivatives, such as triphenyl phosphate, cresyl diphenyl phosphate and tricresyl phosphate and aryl-alkyl derivatives, such as 2-ethylhexyl-diphenyl phosphate and dimethyl-aryl phosphates and octylphenyl phosphate.

Other examples of phosphorous-based flame retardants include methylamine boron-phosphate, cyanuramide phosphate, magnesium phosphate, ethanolamine dimethyl phosphate, cyclic phosphonate ester, trialkyi phosphonates, potassium ammonium phosphate, cyanuramide phosphate, aniline phosphate, trimethylphosphoramide, tris(1-aziridinyl)phosphine oxide, bis(5,5-dimethyl-2-thiono-1,3,2-dioxaphosphorinamyl)oxide, dimethylphosphono-N-hydroxymethyl-3-propionamide, tris(2-butoxyethyl)phosphate, tetrakis(hydroxymethyl)phosphonium salts, such as tetrakis(hydroxymethyl)phosphonium chloride and tetrakis(hydroxymethyl)phosphonium sulfate, n-hydroxymethyl-3-(dimethylphosphono)-propionamide, a melamine salt of boron-polyphosphate, an ammonium salt of boron-polyphosphate, triphenyl phosphite, ammonium dimethyl phosphate, melamine orthophosphate, ammonium urea phosphate, ammonium melamine phosphate, a melamine salt of dimethyl methyl phosphonate, a melamine salt of dimethyl hydrogen phosphite and the like.

In an embodiment, the non-halogenated flame retardant constituent includes a dialkylphosphinic salt of the formula (I) and/or of a diphosphinic salt of the formula (II) and/or polymers thereof is present in the composition according to the invention:

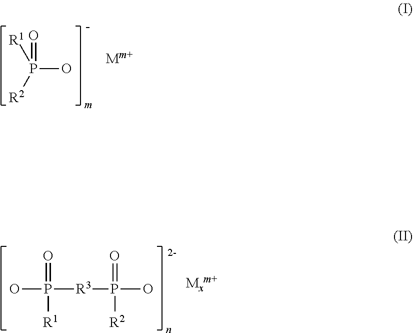

in which
R¹, R² are the same or different and are each linear or branched C₁-C₆-alkyl;
R³ is linear or branched C₁-C₁₀-alkylene, C₆-C₁₀-arylene, C₄-C₂₀-alkylarylene or C₇-C₂₀-arylalkylene;
M is Mg, Ca, Al, Sb, Sn, Ge, Ti, Zn, Fe, Zr, Ce, Bi, Sr, Mn, Li, Na, K and/or a protonated nitrogen base;
m is 1 to 4;
n is 1 to 4; and
x is 1 to 4.

If a dialkylphosphinic salt of the formula (I) and/or of a diphosphinic salt of the formula (II) and/or polymers thereof is present, the composition according to the invention may also comprise a salt of phosphorous acid having the formula (III)

[HP(═O)O₂]²⁻M^{m+} (III)

in which
M is Mg, Ca, Al, Sb, Sn, Ge, Ti, Zn, Fe, Zr, Ce, Bi, Sr, Mn, Li, Na and/or K; and
m is 1 to 4.

Flame-retardants according to the formulae (I) to (III) above are described in, e.g., US2013190432.

In an embodiment, the non-halogenated flame retardant constituent includes an organic phosphorus-containing compound. In an embodiment, the phosphorus-containing compound possesses a phosphorus content of at least 14 wt. % or at least 18 wt. %. An example of such compounds include Amgard P45, and the pure or mixed metal phosphinates (trade name Exolit OP1230 or OP1311, OP1400, and OP1312 by Clariant) as described in, for instance, U.S. Pat. Nos. 4,208,321 and 3,594,347, as well as melamine polyphosphate.

Examples of further phosphorus-containing flame retardants include metal phosphinates, as well as other phosphor containing flame retardants.

Metal phosphinates include metal salts of phosphinic acids and/or diphosphinic acids or polymeric derivatives thereof. Suitably, the metal phosphinate is a metal of a phosphinic acid of the formula

[R¹R²P(O)O]ₘM^{M+} (formula IV) and/or a diphosphinic acid of the formula [O(O)PR¹—R³—PR²(O)O]^{2′}ₙMₓ^{m+} (formula V), and/or a polymer thereof, wherein R¹ and R² are equal or different substituents chosen from the group consisting of hydrogen, linear, branched and cyclic C₁-C₆ aliphatic groups, and aromatic groups,
R³ is chosen from the group consisting of linear, branched and cyclic C₁-C₁₀ aliphatic groups and
C₆-C₁₀ aromatic and aliphatic-aromatic groups,
M is a metal chosen from the group consisting of Mg, Ca, Al, Sb, Sn, Ge, Ti, Zn, Fe, Zr, Ce, Bi, Sr, Mn, Li, Na, and K, and
m, n and x are equal or different integers in the range of 1-4.

Additional phosphorus-containing flame retardants are selected from the groups of the mono- and oligomeric phosphoric and phosphonic acid esters, phosphonate amines, phosphonates, phosphinates, metal dialkylphophinates, especially aluminum tris[dialkylphosphinates] and zinc bis[dialkylphosphinates], phosphites, hypophosphites, phosphine oxides and phosphazenes.

The non-halogenated flame retardant constituent may also include one or more chlorinated flame retardants. Chlorinated flame retardants are disclosed in, e.g., U.S. Pat. Nos. 6,472,456, 5,393,812, 7,230,042 and 7,786,199. Chlorinated flame retardants are for example tris(2-chloroethyl)phosphite, bis-(hexachlorocycloentadeno) cyclooctane, tris(1-chloro-2-propyl)phosphate, tris(2-chloroethyl)phosphate, bis(2-chloroethyl)vinyl phosphate, hexachlorocyclopentadiene, tris(chloropropyl)phosphate, tris(2-chloroethyl)phosphate, tris(chloropropyl)phosphate, polychlorinated biphenyls, mixtures of monomeric chloroethyl phosphonates and high boiling phosphonates, tris(2,3-dichloropropyl)phosphate, chlorendic acid, tetrachlorophthalic acid, poly-p-chloroethyl triphosphonate mixture, bis(hexachlorocyclopentadieno)cyclooctane (DECLORANE PLUS), chlorinated paraffins and hexachlorocyclopentadiene derivatives.

Other suitable halogen-free flame-retardant additives are char former, particularly preferably phenol-formaldehyde resins, polycarbonates, polyimides, polysulfones, polyether sulfones, or polyether ketones.

If employed, the composition can include any suitable amount of a non-halogenated flame retardant constituent, for example, in certain embodiments, relative to the weight of the entire composition, in an amount up to about 50 wt. %, or about 40 wt. %, or about 30 wt. %, or in certain embodiments, in an amount of at least about 5 wt. %, or at least about 10 wt. %, or at least about 20 wt. %, or at least about 30 wt. %. In an embodiment, the non-halogenated flame retardant constituent is present in an amount, relative to the weight of the entire composition, of from 10 wt. % to about 50 wt. %, or from about 20 wt. % to about 50 wt. %, or from about 30 wt. % to about 40 wt. %.

One or more of the aforementioned halogen-free flame retardants described herein may be added to the non-halogenated flame retardant constituent of the flame retardance package in pure form, or in masterbatches or compacts.

### Flame Retardant Synergists

Flame retardant synergists, or as used equivalently herein, simply “synergists”, are often used to enhance the efficiency with which a flame retardant package operates to resist or limit combustion. Synergists tend to most frequently accompany the presence of halogenated flame retardants in particular, although they can improve the function of non-halogenated flame retardants as well. Synergists refer to a group of substances that tend to improve the flame retardance of the composition into which they are associated only in a material fashion when included with an accompanying flame retardant (as described elsewhere herein). They are described in a variety of prior publications, including U.S. Pat. Nos. 4,028,333 and 4,051,101, assigned to the Velsicol Chemical Corporation. Indeed, although alone they are not thought to improve directly the flame retardance of the composition into which they are associated, they often serve to react with the flame retardant to improve its ability in a synergistic fashion.

Flame retardant synergists are well-known in the art to which this invention applies, and commonly include substances such as nacreous pigments, metal oxides or alloys of metal oxides such as antimony tin oxide. Nacreous pigment contains plate-shaped particles with a high refractive index of e.g. a silicate preferably covered with metal oxide. A definition of nacreous pigment is given for instance in the Encyclopaedia of Chemical Technology Kirk-Othmer, third edition (1982), Vol. 17, p. 833. Examples of nacreous pigments that can be used in the composition according to the invention are described in EP0797511.

Commonly known flame retardant synergists include metal compounds further possessing at least one oxygen, nitrogen or sulfur atom. Such examples include zinc oxide, zinc borate, zinc stannate, zinc hydroxystannate, zinc sulfide, molybdenum oxide, titanium dioxide, magnesium oxide, magnesium carbonate, calcium carbonate, calcium oxide, titanium nitride, boron nitride, magnesium nitride, zinc nitride, zinc phosphate, calcium phosphate, calcium borate, magnesium borate, and mixtures thereof.

Further common examples of such flame retardant synergists are those which comprise antimony trioxide, antimony dioxide, sodium antimonate, iron oxide, zinc phosphate and/or a metal salt of boric acid or stannic acid, wherein said metal is selected from the group consisting of zinc, an alkali metal, and an alkaline earth metal. Metal salts of stannic acid include, for example, zinc stannate, zinc hydroxystannate, magnesium stannate, sodium stannate, and potassium stannate. Metal salts of boric acid include, for example, zinc borate, calcium borate, and magnesium borate.

Yet further examples of commonly used synergists include antimony tin oxide, tin oxide, tin orthophosphate, barium titanate, aluminum oxide, copper hydroxyphosphate, copper orthophosphate, potassium copper diphosphate, copper, antimony, and anthraquinone.

Bismuth-based synergists are also known. Examples include those cited in EP2935430, including bismuth trioxide, bismuth oxynitrate, or bismuth oxychloride, (BiOCI) a known pigment that is available for instance from BASF under the tradename MEARLITE. Other cited bismuth oxychloride pigments, which are commercially available and known for use in cosmetic and personal care products include BiOF, BiOBr, BiOI and BiO(NO₃).

Perhaps one of the most widely known and commercially used synergists is antimony trioxide (ATO, or chemically Sb₂O₃). Antimony trioxides are well-known and used to accompany halogenated flame retardants or as laser marking additives, and are described in, for example, EP1196488B1 assigned to DSM IP Assets B.V.

Synergists may be incorporated directly into the composition as a powder or in the form of masterbatches. In an embodiment, the masterbatches are those based on polyamide or those based on polybutylene terephthalate, polyethylene, polypropylene, polyethylene-polypropylene copolymer maleic anhydride grafted polyethylene and/or maleic anhydride grafted polypropylene. The polymers for the masterbatch can be used in the mixture individually or in combinations of two or more. In an embodiment, the synergists is an antimony trioxide that is used in the form of a polyamide 6-based masterbatch.

If employed, the synergists described above can be used singly or in combinations of two or more, and may be incorporated into the composition in any suitable amount.

Despite the prevalence of and long-believed advantages of the synergists described above in flame retardant compositions, inventors have surprisingly discovered that the inclusion of such components does not tend to produce compositions with properties sufficient for many “extreme safety” electrical applications, particularly when synergists are accompanied with the resin matrices and flame retardance packages as prescribed according to the present invention. In particular, inventors discovered that the inclusion of some well-known synergists into compositions according to the present invention tended to negatively impact one or more physical properties (as measure by, for example elongation at break, comparative tracking index, or glow wire ignition temperature) to a level considered unacceptable for their intended application as electrical connectors.

Therefore, in a preferred embodiment, the resin composition contains, relative to the entire composition, less than about 5 wt. %, preferably less than about 3 wt. %, preferably less than 1 wt. %, preferably less than about 0.5 wt %, most preferably less than about 0.1 wt. % of a synergist selected from the group consisting of Sb₂O₃ and ZnBO₄. In a preferred embodiment, the resin composition is substantially devoid of a synergist selected from the group consisting of Sb₂O₃ and ZnBO₄.

In another preferred embodiment, the resin composition contains, relative to the entire composition, less than about 5 wt. %, preferably less than about 3 wt. %, preferably less than 1 wt. %, preferably less than about 0.5 wt %, most preferably less than about 0.1 wt. %, or less than 0.05 wt. % of a synergist selected from the group consisting of Sb₂O₃, SbCl₃, SbBr₃, SbI₃, SbOCI, As₂O₃, As₂O₅, ZnBO₄, stannous oxide hydrate, and bismuth oxychloride. In another preferred embodiment, the resin composition is substantially devoid of a synergist selected from the group consisting of Sb₂O₃, SbCl₃, SbBr₃, SbI₃, SbOCl, As₂O₃, As₂O₅, ZnBO₄, stannous oxide hydrate, and bismuth oxychloride.

In another preferred embodiment, the resin composition contains relative to the entire composition, less than about 5 wt. %, preferably less than about 3 wt. %, preferably less than 1 wt. %, preferably less than about 0.5 wt %, preferably less than about 0.1 wt. %, or less than 0.05 wt. % of any flame retardant synergist. In another preferred embodiment, the resin composition is substantially devoid of a flame retardant synergist altogether.

### Optional Additives

In addition to the constituents mentioned elsewhere herein, supra, compositions according to the present invention may optionally include one or more additives. Suitable additives that can be used in various embodiments of the invention include, for example, flow modifiers (other than the monomeric, oligomeric, or polymeric flow modifiers described elsewhere herein), fillers (including dispersed reinforcing materials such as chopped or milled glass fibers, chopped or milled carbon fibers, nano-fillers, clays, wollastonite and micas, as well as continuous reinforcing materials), pigments, processing aids (such as mold release agents), stabilizers (such as antioxidants and UV stabilizers), plasticizers, impact modifiers, and carrier polymers.

Fillers are known and commonly used in thermoplastic resin compositions. Exemplary fillers include mineral fillers such as clay, mica, talc, and glass spheres. Reinforcing fibers are for example glass fibers. An advantage of a resin composition comprising glass fibers is its increased strength and stiffness, particularly also at higher temperatures, which allows use at temperatures up to close to the melting point of the polymer in the associated composition.

Inorganic substances are especially suitable as fillers because of their tendency to impart water-resistance, heat-resistance, and robust mechanical properties into the composition. In an embodiment of the invention, the filler is inorganic and comprises ceramics such as silica (SiO₂) nanoparticles, i.e., those particles having a mean particle size of from between 1 nanometer (nm) to 999 nm, or microparticles, i.e., those particles having a mean particle size of between 1 micrometer (μm) to 999 μm. Average particle size may be measured using laser diffraction particle size analysis in accordance with ISO13320:2009. A suitable device for measuring the average particle diameter of nanoparticles is the LB-550 machine, available from Horiba Instruments, Inc., which measures particle diameter by dynamic light scattering. Please see U.S. Pat. No. 6,013,714 for further examples of silica nanoparticles.

In other embodiments of the invention, alternative inorganic filler substances may be used, such as those containing glass or metal particles. Certain non-limiting examples of such substances include: glass powder, alumina, alumina hydrate, magnesium oxide, magnesium hydroxide, barium sulfate, calcium sulfate, calcium carbonate, magnesium carbonate, silicate mineral, diatomaceous earth, silica sand, silica powder, oxidation titanium, aluminum powder, bronze, zinc powder, copper powder, lead powder, gold powder, silver dust, glass fiber, titanic acid potassium whiskers, carbon whiskers, sapphire whiskers, verification rear whiskers, boron carbide whiskers, silicon carbide whiskers, and silicon nitride whiskers.

In a preferred embodiment, however, the resin composition according to the present invention is substantially devoid of any fillers at all, when tested according to known methods such as ISO 03451, as inventors have discovered that it is possible to achieve optimal fire and electrical resistivity, all while maintaining sufficient mechanical strength, if such fillers are not incorporated into the resin composition. The absence of fillers is beneficial because it ensures improved workability (i.e. flowability, surface finish, injection molding process compatibility, etc.) of the composition.

Suitable impact modifiers are rubber-like polymers that not only contain apolar monomers such as olefins, but also polar or reactive monomers such as, among others, acrylates and epoxide, acid or anhydride containing monomers. Examples include a copolymer of ethylene with (meth)acrylic acid or an ethylene/propylene copolymer functionalized with anhydride groups. The advantage of impact modifiers is that they do not only improve the impact strength of the resin composition but also contribute to an increase in viscosity. If included, impact modifiers/are present in an amount, relative to the weight of the entire composition, of at least 1 wt. % or at least 5 wt. %, to less than about 60 wt. % or less than about 50 wt. %. A suitable impact modifier is, for example, a maleic anhydride functionalized polyolefin.

Colorants, such as pigments or dyes, may optionally also be included in various embodiments. As colorants, for example, carbon black or nigrosine can be employed. EP2935430 describes various other common pigments such as such as titanium dioxide in its three crystalline forms (rutile, anatase, and brookite), ultramarine blue, iron oxides, bismuth vanadates, effect pigments including metallic pigments such as aluminum flake and pearlescent pigments such as micas, and organic pigments, for example phthalocyanines, perylenes, azo compounds, isoindolines, quinophthalones, diketopyrrolopyrroles, quinacridones, dioxazines, and indanthrones.

Dyes may also be used to impart color into the resin composition. Dyes are any of the colorants which dissolve completely in the plastic used or are present in molecularly dispersed form and therefore can be used to provide high-transparency, non-diffusion coloring of polymers. Other dyes are organic compounds which fluoresce in the visible portion of the electromagnetic spectrum, e.g. fluorescent dyes. If employed, the total amount of colorant (dyes and pigments, collectively) is present, relative to the weight of the entire resin composition, of up to about 5 wt. %.

The composition may additionally and optionally include one or more stabilizers. Stabilizers are known per se and are intended to counter deterioration as a result of the effects of for example heat, light and radicals thereby formed. Known stabilizers that can be applied in the composition are for example hindered amine stabilizers, hindered phenols, phenolic antioxidants, copper salts and halogenides, preferably bromides and iodides, and mixtures of copper salts and halogenides, for example copper iodide/potassium iodide compositions and also phosphites, phosphonites, thioethers, substituted reorcinols, salicylates, benzotriazoles, hindered benzoates, and benzophenones. Preferably, the stabilizer is chosen from the group consisting of inorganic, hindered phenolic oxidant, hindered amine stabilizer and combinations thereof. More preferably, the stabilizers are a combination of inorganic stabilizer, a phenolic antioxidant and a hindered amine. In an embodiment, if the composition includes a stabilizer constituent, such constituent is present by weight, relative to the entire composition, of from about 0.05 wt. % to about 2.0 wt. %, or from about 0.1 to 1.5 wt. %, or from 0.3 wt. % to 1.2 wt. %.

In an embodiment, the resin composition also includes one or more mold release agents. Also known as lubricants, these substances include long chain fatty acids, especially stearic acid or behenic acid, salts thereof, especially Ca or Zn stearate, as well as their ester derivatives or amide derivatives, in particular ethylene-bis-stearylamid, montan waxes and low molecular weight polyethylene or polypropylene waxes. In an embodiment, suitable mold release agents include esters or amides of saturated or unsaturated aliphatic carboxylic acids having 8 to 40 carbon atoms with saturated aliphatic alcohols or amines having from 2 to 40 carbon atoms, and metal salts of saturated or unsaturated aliphatic carboxylic acids with 8 to 40 carbon atoms used with ethylene bis-stearyl amide, and calcium stearate.

The aforementioned lists of additives is not intended to be limiting, and any other suitable additive may be employed as is generally known to those of skill in the art to which this invention applies. Further such examples include UV stabilizers, gamma ray stabilizers, hydrolysis stabilizers, thermal stabilizers, antistatic agents, emulsifiers, nucleating agents, drip agents (such as polytetrafluoroethylene or polyvinylpyrrolidone), and plasticizers.

If included, the additives described herein may be used singly or in combinations of two or more, and may be incorporated directly into the resin composition or in the form of masterbatches.

In an embodiment, the total amount of additives can be incorporated in any suitable amount, such as from 0.1-2 wt. %, or even less, up to 50 to 60 wt. % or more, relative to the weight of the entire composition into which such additives are incorporated. In an embodiment, the composition includes from 0 to about 60 wt. %, or from 0 to about 50 wt. %, or from 0 to about 40 wt. %, or from 0 to about 20 wt. % of one more additives.

The thermoplastic resin compositions according to the present invention can be prepared in any customary manner. All of the individual compositional constituents may be added individually, or by use of a so-called masterbatch composition, whereby certain groups of constituents (such as the flame retardance package or resin matrix, by way of a non-limiting example) may be first mixed in desired ratios, optionally in a diluent, following which the masterbatch is added and mixed with the remaining components of the thermoplastic resin composition. Also, the components may be dry blended and consequently fed into a melt mixing apparatus such as an extruder. Also the components can be directly fed into a melt mixing apparatus and dosed together or separately. In that case the composition is obtained in pellets that can be used for further processing, for instance in injection molding. If employed, the melt mixing process is preferably carried out in an inert gas atmosphere and the materials are dried before mixing.

The invention also relates to articles made wholly of partly of the thermoplastic resin compositions according to the present invention. All known techniques for the preparation of the articles from the resin composition can be used, like for example injection molding, blow molding, casting, extrusion, etc. In another embodiment the article may comprise a substrate having a coating thereon of the resin composition according to the invention. Such article may be formed by applying a pre-polymer composition on the substrate and then in-situ polymerizing to form the resin composition. The invention also relates to articles, for example electric or electronic components such as home appliance electrical contacts, comprising the resin composition according to the invention.

The following examples further illustrate the invention but, of course, should not be construed as in any way limiting its scope.

### EXAMPLES

These examples illustrate embodiments of the thermoplastic resin composition of the instant invention. Table 1 describes the various components of the compositions used in the present examples.

TABLE 1

| | Function in | | Supplier/ |
|---|---|---|---|
| Component | Formula | Chemical Descriptor | Manufacturer |
| Vydyne ® 21A1 | Resin matrix | Polyamide 6,6 base polymer, | Ascend |
| | constituent | spherical shape granules, free of | Performance |
| | | visual impurities | Materials |
| Vydyne 21A1 | Resin matrix | Polyamide 6,6 base polymer, | Ascend |
| powder | constituent | natural color powder | Performance |
| | | | Materials |
| Saytex ® HP 7010 | Halogenated | Brominated polystyrene | Albemarle |
| | flame retardant | | |
| Acrawax C EBS | Mold Release | N,N′-Ethylenebis(stearamide) | Pacific Coast |
| | Agent | | Chemicals |
| Thanox 1098 | Stabilizer | 3,3′-Bis(3,5-di-tert-butyl-4- | Rianlon |
| | | hydroxyphenyl)-N,N′- | Corporation |
| | | hexamethylenedipropionamide | |
| Akulon ® K- | Non-halogenated | Melamine cyanurate (40 wt. %) in | DSM |
| X6434 | flame retardant + | polyamide 6 carrier (60 wt. %) | Engineering |
| | resin matrix | | Plastics |
| | constituent | | |
| Volgamid PA6 | Resin matrix | Polyamide 6 base polymer | JSC |
| | constituent | | Kuibyshev- |
| | | | Azot |
| JY-1180M | Synergist | Masterbatch of 80% antimony | Shanghai |
| | | trioxide + 20% polyamide 6 | Juyuan Flame |
| | | carrier | Retardant |
| | | | Material |
| | | | Co., Ltd. |
| Firemaster ® PBS- | Halogenated | Polydibromostyrene | Great Lakes |
| 64HW | flame retardant | CAS Reg. Number [88497-56-7] | Solutions |

### Examples 1-5

Various thermoplastic resin compositions including a resin matrix, flame retardance package, and select additives were prepared according to well-known methods in the art by combining the components listed in Table 1 above. The compositions corresponding to Examples 1 through 5 appear in Table 2 below.

Approximately 14 kg of all such compositions were compounded on a 25 mm co-rotating twin screw extruder (Berstorff ZE25UTX) at a throughput of between 25-30 kg/hr, with a screw speed of approximately 380 rpm and torque setting of between 49%-55%. The melt pressure was set at from 10-14 Bar, and the melt temperature controlled to from 274° C. to 288° C. The final compositions were molded into various shapes for property testing:
50×70×0.5 mm, 90×90×1.0 mm, 90×90×1.6 mm, and 50×70×0.5 mm plaques for GWIT and/or GWFI testing
0.4, 0.8, and 1.6 mm UL94V specimens for the vertical burning test

GWFI tests were conducted in accordance with IEC60695-2-12. CTI testing was done in accordance with IEC60112 (with solution A) and vertical burning tests were conducted in accordance to UL 94V. Tensile modulus, tensile strength, and elongation at break were tested in accordance with ISO527. Charpy notched and unnotched tests were conducted in accordance with ISO179/1eA and ISO179/1eU, accordingly.

Reported are performance values of various physical characteristics, which are explained below and depicted in Table 3. All values are listed in parts by weight unless otherwise denoted.

TABLE 2
All values are listed in parts by weight

| | Ex. 1 | Ex. 2 | Ex. 3 | Ex. 4 | Ex. 5 |
|---|---|---|---|---|---|
| Vydene 21A1 | 62.20 | 62.20 | 62.20 | 63.20 | 60.20 |
| Vydene 21A1 | 3.00 | 3.00 | 3.00 | 3.00 | 3.00 |
| powder | | | | | |
| Saytex HP710 | 0.00 | 27.00 | 21.00 | 22.00 | 27.00 |
| Arcawax C | 0.30 | 0.30 | 0.30 | 0.30 | 0.30 |
| EBS | | | | | |
| Thanox 1098 | 0.50 | 0.50 | 0.50 | 0.50 | 0.50 |
| K-X6434 | 0.00 | 0.00 | 0.00 | 10.00 | 5.00 |
| Volgamid | 7.00 | 7.00 | 7.00 | 1.00 | 4.00 |
| PA6 | | | | | |
| JY-1180M | 0.00 | 0.00 | 6.00 | 0.00 | 0.00 |
| PBS-64HW | 27.00 | 0.00 | 0.00 | 0.00 | 0.00 |
| TOTALS | 100.00 | 100.00 | 100.00 | 100.00 | 100.00 |

TABLE 3

| | Ex. 1 | Ex. 2 | Ex. 3 | Ex. 4 | Ex. 5 |
|---|---|---|---|---|---|
| Elongation at | 3.01 | 18.84 | 5.49 | 6.97 | 15.61 |
| break (%) | | | | | |
| Efmax | 2.88 | 4.43 | 3.62 | 4.02 | 4.65 |
| Charpy Notched | 1.88 | 3.39 | 3.36 | 3.27 | 3.33 |
| Charpy | 40.34 | 74.34 | 74.3 | 46.25 | 62.72 |
| Unnotched | | | | | |
| L | 87.71 | 81.06 | 90.72 | 86.2 | 88.61 |
| A | 0.15 | 1.2 | 0.48 | 0.61 | 0.38 |
| B | 11.52 | 21.36 | 11.88 | 17.26 | 14.94 |
| Density | 1.299 | 1.302 | 1.302 | 1.283 | 1.308 |
| UL 0.8 mm, | V-2 | V-0 | V-2 | V-0 | V-0 |
| 48 hours | | | | | |
| t1 + t2 | 16.2 | 22.1 | 21.1 | 23.1 | 27.6 |
| UL 1.6 mm, | V-2 | V-0 | V-0 | V-0 | V-0 |
| 48 hours | | | | | |
| t1 + t2 | 18.2 | 24.9 | 20.6 | 18.7 | 19 |
| UL 0.4 mm, | V-2 | V-2 | V-0 | V-0 | V-0 |
| 48 hours | | | | | |
| t1 + t2 | 19.5 | 20.2 | 18.3 | 18.9 | 16.5 |
| GWIT (plaque | 960° C. | 960° C. | 960° C. | 960° C. | 960° C. |
| 50 × 70 × 0.5 mm), | | | | | |
| standard test | | | | | |
| GWIT (plaque | 960° C. | 960° C. | 850° C. | 960° C. | 930° C. |
| 90 × 90 × 1.0 mm), | | | | | |
| standard test | | | | | |
| GWIT (plaque | 930° C. | 930° C. | 775° C. | 930° C. | 960° C. |
| 90 × 90 × 1.6 mm), | | | | | |
| standard test | | | | | |
| GWIT (plaque | 825° C. | 850° C. | 800° C. | 900° C. | 850° C. |
| 50 × 70 × 0.5 mm), | | | | | |
| no flame temp. | | | | | |
| GWIT (plaque | 825° C. | 825° C. | 750° C. | 875° C. | 900° C. |
| 90 × 90 × 1.0 mm), | | | | | |
| no flame temp. | | | | | |
| GWIT (plaque | 875° C. | 900° C. | 750° C. | 900° C. | 900° C. |
| 90 × 90 × 1.6 mm), | | | | | |
| no flame temp. | | | | | |
| GWIT (plaque | No data | No data | No data | No data | 930° C. |
| 90 × 90 × 3.0 mm), | | | | | |
| no flame temp. | | | | | |
| GWFI (Plaque | Pass GWFI | Pass GWFI | Pass GWFI | Pass GWFI | Pass GWFI |
| 50 × 70 × 0.5 mm) | 960° C./0.5 mm | 960° C./0.5 mm | 960° C./0.5 mm | 960° C./0.5 mm | 960° C./0.5 mm |
| GWFI (Plaque | Pass GWFI | Pass GWFI | Pass GWFI | Pass GWFI | Pass GWFI |
| 90 × 90 × 1.0 mm) | 960° C./1.0 mm | 960° C./1.0 mm | 960° C./1.0 mm | 960° C./1.0 mm | 960° C./1.0 mm |
| GWFI (Plaque | Pass GWFI | Pass GWFI | Pass GWFI | Pass GWFI | Pass GWFI |
| 90 × 90 × 1.6 mm) | 960° C./1.6 mm | 960° C./1.6 mm | 960° C./1.6 mm | 960° C./1.6 mm | 960° C./1.6 mm |
| GWFI (Plaque | No data | No data | No data | No data | Pass GWFI |
| 90 × 90 × 3.0 mm) | | | | | 960° C./3.0 mm |
| CTI | 550 V | 500 V | 375 V | 550 V | 475 V |

### Discussion of Results

As can be seen, thermoplastic resin compositions according to the present invention yield suitable physical performance when evaluated according to elongation at break, Efmax, toughness (as measured by charpy notched & unnotched), L, a, b, and density, as well as simultaneously also exhibiting superior heat resistance as measured by UL94, GWIT and GWFI, and exceptional electrical resistivity as evaluated according to CTI.

### Additional Exemplary Embodiments

A first aspect of a first additional exemplary embodiment is a composition comprising, relative to the weight of the entire composition:
a resin matrix comprising a blend of at least two thermoplastic polymers;
a flame retardance package; and
optionally, up to about 70 wt. %, or up to about 50 wt. %, or up to about 20 wt. % of one or more additives;
wherein the ratio by weight of the first thermoplastic polymer to the second thermoplastic polymer is from about 1:1 to about 75:1, or from about 1:1 to about 50:1, or from about 5:1 to about 75:1, or from about 5:1 to about 25:1.

A second aspect of the first additional exemplary embodiment is the composition of the first aspect of the first additional exemplary embodiment, wherein the resin matrix comprises at least one polyamide.

A third aspect of the first additional exemplary embodiment is the composition of any of the previous aspects of the first additional exemplary embodiment, wherein the resin matrix comprises at least two polyamides.

A fourth aspect of the first additional exemplary embodiment is the composition of the second or third aspects of the first additional exemplary embodiment, wherein at least one polyamide is an aliphatic polyamide.

A fifth aspect of the first additional exemplary embodiment is the composition of any of the previous aspects of the first additional exemplary embodiment, wherein the composition is substantially devoid of an antimony trioxide compound.

A sixth aspect of the first additional exemplary embodiment is the composition of any of the previous aspects of the first additional exemplary embodiment, wherein the composition is substantially devoid of a flame retardant synergist.

A seventh aspect of the first additional exemplary embodiment is the composition of any of the previous aspects of the first additional exemplary embodiment, wherein at least one thermoplastic polymer possesses a molar heat capacity Cₚ of at least about 250 J(mol K)⁻¹, or at least about 275 J(mol K)⁻¹, or at least about 300 J(mol K)⁻¹, or at least about 325 J(mol K)⁻¹.

An eighth aspect of the first additional exemplary embodiment is the composition of any of the previous aspects of the first additional exemplary embodiment, wherein at least one thermoplastic polymer possesses a molar heat capacity Cₚ of less than about 325 J(mol K)⁻¹, or less than about 300 J(mol K)⁻¹, or less than about 275 J(mol K)⁻¹, or less than about 250 J(mol K)⁻¹.

An ninth aspect of the first additional exemplary embodiment is the composition of any of the previous aspects of the first additional exemplary embodiment, wherein the composition is capable of attaining a glow wire ignition temperature (GWIT) from 0.4 mm to 1.6 mm, or from 0.2 mm to 3.2 mm, of at least about 800 C, more preferably at least about 850° C., more preferably at least about 900° C., more preferably at least about 960° C.

A tenth aspect of the first additional exemplary embodiment is the composition of any of the previous aspects of the first additional exemplary embodiment, wherein the composition attains a rating of V-0 when tested under UL94-V from a sample thickness of from 0.4 to 1.6 mm.

An eleventh aspect of the first additional exemplary embodiment is the composition of any of the previous aspects of the first additional exemplary embodiment, wherein the composition attains a comparative tracking index (CTI) value of at least about 350 V, more preferably at least about 400 V, more preferably at least about 450 V.

A twelfth aspect of the first additional exemplary embodiment is the composition of any of the previous aspects of the first additional exemplary embodiment, wherein the composition attains an elongation at break of at least about 3%, more preferably at least about 5%, more preferably at least about 6%, more preferably at least about 15%.

A thirteenth aspect of the first additional exemplary embodiment is the composition of any of the previous aspects of the first additional exemplary embodiment, wherein the composition attains a glow wire flammability index (GWFI) from 0.4 mm to 1.6 mm, or from 0.2 mm to 3.2 mm, of at least about 800° C., more preferably at least about 850° C., more preferably at least about 900° C., more preferably at least about 960° C.

A fourteenth aspect of the first additional exemplary embodiment is the composition of any of the previous aspects of the first additional exemplary embodiment, wherein the composition is substantially devoid of a filler.

A first aspect of a second additional exemplary embodiment is a thermoplastic resin composition comprising, relative to the weight of the entire composition:
a resin matrix comprising a blend of at least a first aliphatic polyamide and a second aliphatic polyamide;
a flame retardance package comprising
   an halogenated flame retardant constituent and
   a non-halogenated flame retardant constituent; and
optionally, up to about 70 wt. %, or up to about 50 wt. %, or up to about 20 wt. % of one or more additives;
wherein the ratio by weight of the first aliphatic polyamide to the second aliphatic polyamide is from about 1:1 to about 75:1, or from about 1:1 to about 50:1, or from about 5:1 to about 75:1, or from about 5:1 to about 25:1;
wherein the first aliphatic polyamide possesses a melting point that is higher than the melting point of the second aliphatic polyamide;
and wherein the resin composition contains less than about 5 wt. %, or less than about 3 wt. %, or less than about 1 wt. %, or less than about 0.5 wt. %, or less than about 0.1 wt. %, or less than about 0.05 wt. % of an antimony trioxide synergist.

A second aspect of the second additional exemplary embodiment is the thermoplastic resin composition of the first aspect of the second exemplary embodiment, further wherein the resin composition also contains less than about 5 wt. %, or less than about 3 wt. %, or less than about 1 wt. %, or less than about 0.5 wt. %, or less than about 0.1 wt. % of one or more synergists selected from the group consisting of Sb₂O₃, SbCl₃, SbBr₃, SbI₃, SbOCl, As₂O₃, As₂O₅, ZnBO₄, stannous oxide hydrate, and bismuth oxychloride.

A third aspect of the second additional exemplary embodiment is the thermoplastic resin composition of any of the previous aspects of the second additional exemplary embodiment, wherein the first aliphatic polyamide possesses a molar heat capacity Cₚ of at least about 275 J(mol K)⁻¹, or at least about 300 J(mol K)⁻¹; and the second aliphatic polyamide possesses a molar heat capacity Cₚ of less than about 275 J(mol K)⁻¹, or less than about 250 J(mol K)⁻¹, wherein molar heat capacity Cₚ is determined according to ASTM E1269-11.

A fourth aspect of the second additional exemplary embodiment is the thermoplastic resin composition of any of the previous aspects of the second additional exemplary embodiment, wherein at least one halogenated flame retardant compound of the halogenated flame retardant constituent is selected from the group consisting of epoxidized tetrabromobisphenol A resin, tetrachlorobisphenol A oligocarbonate, pentabromopolyacrylate, ethylene-1,2-bistetrabromophthalimide, brominated polystyrene, bis (pentabromophenyl) ethane, and tetrabromobisphenol A oligocarbonate.

A fifth aspect of the second additional exemplary embodiment is the thermoplastic resin composition of any of the previous aspects of the second additional exemplary embodiment, wherein at least one non-halogenated flame retardant compound of the non-halogenated flame retardant constituent is selected from the group consisting of guanidine carbonate, guanidine cyanurate, guanidine phosphate, pentaerythritol boric acid, melamine cyanurate, neopentylglycolboric acid guanidine, urea phosphate and urea cyanurate.

A sixth aspect of the second additional exemplary embodiment is the thermoplastic resin composition of any of the previous aspects of the second additional exemplary embodiment, wherein the resin matrix is present in an amount, relative to the weight of the entire composition, of from about 30 wt. % to about 80 wt. %, more preferably from about 50 wt. % to about 80 wt. %, more preferably from about 60 wt. % to about 75 wt. %.

A seventh aspect of the second additional exemplary embodiment is the thermoplastic resin composition of any of the previous aspects of the second additional exemplary embodiment, wherein the flame retardance package is present in an amount, relative to the weight of the entire composition, of from 10 wt. % to about 60 wt. %, more preferably from about 20 wt. % to about 50 wt. %, more preferably from about 30 wt. % to about 40 wt. %.

An eight aspect of the second additional exemplary embodiment is the thermoplastic resin composition of any of the previous aspects of the second additional exemplary embodiment, wherein the ratio by weight of the halogenated flame retardant constituent to the non-halogenated flame retardant constituent is from about 2:1 to about 15:1, more preferably from about 4:1 to about 10:1.

A ninth aspect of the second additional exemplary embodiment is the thermoplastic resin composition of any of the previous aspects of the second additional exemplary embodiment, wherein the first aliphatic polyamide is a polyamide 66.

A tenth aspect of the second additional exemplary embodiment is the thermoplastic resin composition of any of the previous aspects of the second additional exemplary embodiment, wherein the second aliphatic polyamide is a polyamide 6.

An eleventh aspect of the second additional exemplary embodiment is the thermoplastic resin composition of any of the previous aspects of the second additional exemplary embodiment, wherein the resin matrix is substantially devoid of a co-polyamide of polyamide 6 and polyamide 66.

A twelfth aspect of the second additional exemplary embodiment is the thermoplastic resin composition of any of the previous aspects of the second additional exemplary embodiment, wherein the composition is substantially devoid of a filler.

A thirteenth aspect of the second additional exemplary embodiment is the thermoplastic resin composition of any of the previous aspects of the second additional exemplary embodiment, wherein the additives comprise one or more of a release agent, a heat stabilizer, and an anti-dripping agent.

A fourteenth aspect of the second additional exemplary embodiment is the thermoplastic resin composition of any of the previous aspects of the second additional exemplary embodiment, wherein the anti-dripping agent comprises a polytetrafluoroethylene or a polyvinylpyrrolidone.

A fifteenth aspect of the second additional exemplary embodiment is the thermoplastic resin composition of any of the previous aspects of the second additional exemplary embodiment, wherein the composition is substantially devoid of a flame retardant synergist.

A sixteenth aspect of the second additional exemplary embodiment is the thermoplastic resin composition of any of the previous aspects of the second additional exemplary embodiment, wherein the composition, after having formed a solid polymer by an injection molding process, is capable of attaining a glow wire ignition temperature (GWIT) from 0.4 mm to 1.6 mm, or from 0.2 mm to 3.2 mm, of at least about 800 C, more preferably at least about 850° C., more preferably at least about 900° C., more preferably at least about 960° C.

A seventeenth aspect of the second additional exemplary embodiment is the thermoplastic resin composition of any of the previous aspects of the second additional exemplary embodiment, wherein the composition, after having formed a solid polymer by an injection molding process, attains a rating of V-0 when tested under UL94-V from a sample thickness of from 0.4 to 1.6 mm.

An eighteenth aspect of the second additional exemplary embodiment is the thermoplastic resin composition of any of the previous aspects of the second additional exemplary embodiment, wherein the composition attains a comparative tracking index (CTI) value of at least about 350 V, more preferably at least about 400 V, more preferably at least about 450 V.

A nineteenth aspect of the second additional exemplary embodiment is the thermoplastic resin composition of any of the previous aspects of the second additional exemplary embodiment, wherein the composition attains an elongation at break of at least about 3%, more preferably at least about 5%, more preferably at least about 6%, more preferably at least about 15%.

A twentieth aspect of the second additional exemplary embodiment is the thermoplastic resin composition of any of the previous aspects of the second additional exemplary embodiment, wherein the composition, after having formed a solid polymer by an injection molding process, is capable of attaining a glow wire flammability index (GWFI) from 0.4 mm to 1.6 mm, or from 0.2 mm to 3.2 mm, of at least about 800 C, more preferably at least about 850° C., more preferably at least about 900° C., more preferably at least about 960° C.

A first aspect of a third additional exemplary embodiment is an article formed from the thermoplastic resin composition of any of the aspects of either the first or second additional exemplary embodiments.

Unless otherwise specified, the term wt. % means the amount by mass of a particular constituent or component relative to the entire thermoplastic resin composition into which it is incorporated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been described in detail and with reference to specific embodiments thereof, it will be apparent to one of ordinary skill in the art that various changes and modifications can be made therein without departing from the spirit and scope of the claimed invention.

1. A thermoplastic resin composition comprising, relative to the weight of the entire thermoplastic resin composition:
a resin matrix comprising a blend of at least a first polyamide and a second polyamide;
a flame retardance package comprising
a halogenated flame retardant constituent; and
a non-halogenated flame retardant constituent; and
from 0 wt. % up to about 40 wt. % of one or more additives;
wherein the ratio by weight of the first polyamide to the second polyamide is from about 5:1 to about 75:1;
wherein the first polyamide possesses a melting point that is higher than the melting point of the second polyamide;
and
wherein the resin composition contains less than about 1 wt. % of an antimony trioxide.

2. The thermoplastic resin composition of claim 1, wherein the resin composition contains less than about 0.1 wt. % of an antimony trioxide.

3. The thermoplastic resin composition of claim 2, wherein the resin composition contains less than about 0.1 wt. % of a flame retardant synergist constituent, wherein the flame retardant synergist constituent is selected from one or more of the group consisting of Sb₂O₃, SbCl₃, SbBr₃, SbI₃, SbOCl, As₂O₃, As₂O₅, ZnBO₄, stannous oxide hydrate, and bismuth oxychloride.

4. The thermoplastic resin composition of claim 3, wherein the first polyamide is aliphatic and possesses a molar heat capacity Cₚ of at least about 275 J(mol K)⁻¹, wherein the molar heat capacity Cₚ is determined according to ASTM E1269-11.

5. The thermoplastic resin composition of claim 4, wherein the second polyamide is aliphatic and possesses a molar heat capacity Cₚ of less than about 275 J(mol K)⁻¹, wherein the molar heat capacity Cₚ is determined according to ASTM E1269-11.

6. The thermoplastic resin composition of claim 5, wherein the halogenated flame retardant constituent comprises at least one halogenated flame retardant compound selected from the group consisting of epoxidized tetrabromobisphenol A resin, tetrachlorobisphenol A oligocarbonate, pentabromopolyacrylate, ethylene-1,2-bistetrabromophthalimide, brominated polystyrene, bis(pentabromophenyl)ethane, and tetrabromobisphenol A oligocarbonate.

7. The thermoplastic resin composition of claim 5, wherein the non-halogenated flame retardant constituent comprises at least one non-halogenated flame retardant compound selected from the group consisting of guanidine carbonate, guanidine cyanurate, guanidine phosphate, pentaerythritol boric acid, melamine cyanurate, neopentylglycolboric acid guanidine, urea phosphate and urea cyanurate.

8. The thermoplastic resin composition of claim 5, wherein the resin matrix is present in an amount, relative to the weight of the entire thermoplastic resin composition, from about 30 wt. % to about 80 wt. %.

9. The thermoplastic resin composition of claim 8, wherein the flame retardance package is present in an amount, relative to the weight of the entire composition, from 10 wt. % to about 60 wt. %.

10. The thermoplastic resin composition of claim 9, wherein the ratio by weight of the halogenated flame retardant constituent to the non-halogenated flame retardant constituent is from about 2:1 to about 15:1.

11. The thermoplastic resin composition of claim 10, wherein the first aliphatic polyamide is a polyamide 66.

12. The thermoplastic resin composition of claim 11, wherein the second aliphatic polyamide is a polyamide 6.

13. The thermoplastic resin composition of claim 12, wherein the additives comprise one or more of a release agent, a filler, a heat stabilizer, and an anti-dripping agent.

14. The thermoplastic resin composition of claim 13, wherein the anti-dripping agent comprises a polytetrafluoroethylene or a polyvinylpyrrolidone.

15. The thermoplastic resin composition of claim 12, wherein the composition is substantially devoid of a flame retardant synergist.

16. The thermoplastic resin composition of claim 12, wherein the composition, after having formed a solid polymer by an injection molding process, is capable of attaining a glow wire ignition temperature (GWIT) from about 0.5 mm to about 3.0 mm of at least about 850° C.

17. The thermoplastic resin composition claim 16, wherein the composition is configured to attain a rating of V-0 when tested under UL94-V from a sample thickness from about 0.4 mm to about 1.6 mm.

18. The thermoplastic resin composition of claim 17, wherein the composition is configured to attain a comparative tracking index (CTI) value of at least about 450 V.

19. The thermoplastic resin composition of claim 18, wherein the composition, after having formed a solid polymer by an injection molding process, is configured to attain a glow wire flammability index (GWFI) from about 0.5 mm to about 3.0 mm of about 960° C.

20. An article formed from the thermoplastic resin composition of any one of claims 1-19.
